(19) United States
(12) Patent Application Publication
(10) Pub. No.: US 2002/0031656 A1
(43) Pub. Date: Mar. 14, 2002

(54) Formed building material and room

(75) Inventors: Makoto Kotama, Aichi (JP); Hiroshi Fukumizu, Aichi (JP); Yukio Matsumoto, Aichi (JP); Masanari Toyama, Aichi (JP); Katsumi Yamamoto, Aichi (JP); Mitsunori Endo, Aichi (JP); Shigeru Yokoyama, Aichi (JP)

Correspondence Address: KANESAKA AND TAKEUCHI, 1423 Powhatan Street, Alexandria, VA, 22314, US

(73) Assignee: INAX CORPORATION

(21) Appl. No.: 09/969,574

(22) Filed: Oct. 4, 2001

Related U.S. Application Data
(63) Continuation-in-part of application No. 09/261,962, filed on Mar. 3, 1999, now abandoned.
(63) Continuation-in-part of application No. 09/571,322, filed on May 15, 2000.
(63) Continuation-in-part of application No. 09/832,207, filed on Apr. 11, 2001.

(30) Foreign Application Priority Data
Mar. 4, 1998 (JP) H10-52152
Dec. 10, 1998 (JP) H10-351606
Jun. 2, 1999 (JP) H11-155331

(51) Int. Cl. B32B 17/06; B32B 3/26

(52) U.S. Cl. 428/304.4; 428/426

(57) ABSTRACT

A formed building material is provided of which front surface is allowed to be glazed, thereby improving its decorative property and improving its soil resistance and which has hazardous substance adsorbing function. This formed building material is produced by baking, a glaze is applied to a front surface of a main body of the formed building material, and the specific surface area of the main body is 10 m²/g or more. The main body has porosity of 20-50%, and more than 40% of pores of the main body have a radius of less than 0.1 μm. The glaze forms a glass layer on 90% or less of the entire surface area of the main body and/or the maximum thickness of the glass layer formed by the glaze is 300 μm or less. The formed building material is attached to a lower portion of a wall and/or a floor of a room.

### CROSS REFERENCE TO RELATED APPLICATION

This is a continuation-in-part application of patent application Ser. Nos. 261,962 filed on Mar. 3, 1999, 571,322 filed on May 15, 2000, and 832,207 filed on Apr. 11, 2001.

### FIELD OF THE INVENTION

The present invention relates to a formed building material having hazardous substance adsorbing function and, more particularly, to a formed building material of which front surface is allowed to be glazed, thereby improving its decorative property and improving its soil resistance.

### DESCRIPTION OF PRIOR ART

In humid areas including East Asia, conventionally, houses had been built with wood frames and clayey walls, thereby accomplishing good humidity condition and moisture condensation proof. Recently, since high air-tightness is required in buildings and houses, synthetic resin coating boards providing excellent fire resistance and air-tightness are widely used. However, the synthetic resin coating boards have a problem of producing hazardous substance such as formaldehyde.

One of means for solving the problem is the installation of an air purifier. However, since such a device requires a motive power, this means is not preferable in view of the facility cost and the running cost.

Accordingly, formed building materials (products) have been developed which have an air-purifying function itself and is thus capable of purifying air without another air purifier and any motive power. As one example of such materials, JPA H09-151544 discloses a formed building material composed of cellular concrete in which a zeolite particles are mixed. Deodorization and purification of air can be performed by ion exchange action and adsorption action of the zeolite particles in the formed building material used for an exterior wall.

Since the formed building material composed of cellular concrete is not allowed to be glazed, however, ways for decorating the material are limited, thus decreasing the degree of design freedom. In addition, the formed building material has disadvantages that it is easily soiled by fingers and the stain is hard to come out.

### OBJECT AND SUMMARY OF THE INVENTION

The object of the present invention is to solve the aforementioned conventional problems and to provide a formed building material which has hazardous substance adsorbing function and of which front surface is allowed to be glazed, thereby improving its decorative property and improving its soil resistance. It is another object of the present invention to provide a room built by using the improved formed building materials.

The present invention provides a formed building material produced by baking wherein a glaze is applied to a front surface of a main body of the formed building material (hereinafter, sometimes referred to as only “the main body”) and wherein the specific surface area of the main body is 10 m²/g or more. The main body has porosity of 20-50%, and more than 40% of pores of the main body have a radius of less than 0.1 μm.

The formed building material of the present invention has a large specific surface area and has hazardous substance adsorbing function. Since the front surface is glazed, various decoration may be applied by the glaze, thereby increasing the degree of design freedom. It is hardly soiled by fingers and it is easily cleaned even if soiled, thereby allowing the surface to be always clean.

Due to the glazing on the front surface of the main body, the adsorbing speed of hazardous substance is slightly slowed but the adsorbing capacity is not or little changed. Therefore, the function of the material as a hazardous substance adsorbing material is not lost.

The glaze preferably forms a glass layer on 90% or less of the entire front surface area of the main body. In addition, the maximum thickness of the glass layer formed by the glaze is preferably 300 μm or less.

When the formed building materials of the present invention are attached to a lower portion of a wall or a floor of a room, hazardous substances can be adsorbed and removed from air within the room, particularly from air in a lower portion of the room. As for an upper portion of the wall and the ceiling, the formed building materials of the present invention may be or may not be attached. The formed building may be attached both of the lower portion of the wall and the floor. The term “room” used herein means any space in a building including a kitchen, a trunk room, a sanitary room, a corridor, a staircase as well as an accommodation room.

According to the present invention, it is preferable that the formed building materials are attached such that the air volume ratio R is 0.1 (m²/m³) or more wherein the air volume ratio is obtained by dividing the area A (m²) where the formed building materials are attached with the capacity B (m³) of the room. That is, it is preferable that the formed building materials are attached to enough area such that the value of R=A/B is 0.1 ore more.

### BRIEF DESCRIPTION OF THE DRAWING

FIG. 1 is a vertical sectional view of a lower portion of a wall and a floor of a room as a working example using formed building materials;

FIG. 2 is a diagram showing distribution of pores; and

FIG. 3 is a diagram showing moisture-absorbing-and-desorbing-performance.

### DETAILED DESCRIPTION OF THE PREFERRED EMBODIMENTS

In the present invention, a formed building material is prepared by baking. A main body of the formed building material is baked before or after the glazing.

To manufacture the formed building material of the present invention, one or more of porous materials such as volcanic pumice deposits produced in various areas, e.g. called as Kanumatsuchi and Ohsawatsuchi including allophane and imogolite, colloid soils, Mizutsuchi, and Misotsuchi, and diatomaceous earth, acid clay, activated clay, zeolite, halloysite, and sepiolite is first prepared. Preferably, kibushi-clay and/or potter's clay is added for the purpose of obtaining formability and vitreous particles of one or more of silica stone, pottery stone, phrophyllite, and feldspar are mixed for the purpose of improving the degree of sintering at ratios within the following ranges. The resultant mixture is formed by extrusion molding or press molding into a plate-like or block-like product.

It should be noted that “kanuma-tsuchi” is a popular name of Kanuma pumice bed. “Kanuma” is a name of a city at Tochigi prefecture near Akagi volcano in Japan. “kanuma-tsuchi” is a volcanic product from the center crater of Akagi volcano (ca. 32 thousands years ago). It is a porous weathering pumice compound of allophane as clays, showing the lighthology of pyroxene andesite including amphibole.

Porous raw material such as Kanumatsuchi: 100 parts by weight

Clay: 100-1000 parts by weight

Vitreous material: 0-500 parts by weight

The “miso-tsuchi” and “osawa-tsuchi” are also ones of weathering pumices at specific areas in Japan. The kibushi-clay is typical clay in Japan consisting mainly of Kaolinite.

The molded product is baked after glazing. Alternatively, the molded product is first baked, after that, glazed, and then further baked. In this way, the formed building material of this embodiment is manufactured. The specific surface area of a main body of the formed building material is 10 m²/g or more, preferably 15 m²/g or more, more preferably 20 m²/g or more. This specific surface area is achieved by the aforementioned porous row material such as Kanumatsuchi.

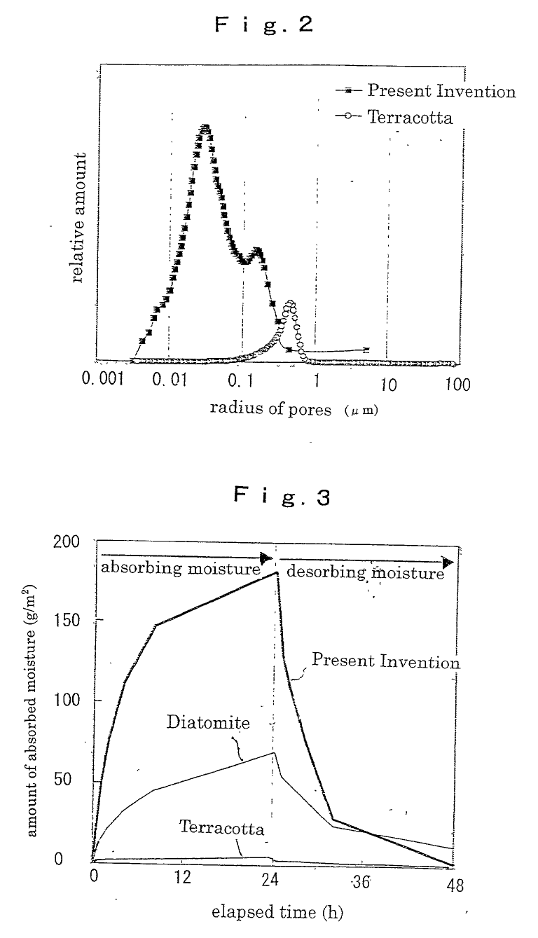

The main body of the building material according to the present invention has porosity of 20-50%, and more than 40% of pores of the body have a radius of less than 0.1 μm. As shown in FIG. 2, the main body has very fine pores so that it has an extremely excellent property in absorbing and disorbing moisture. The building material of the present invention absorbs and disorbs moisture in an amount of more than 2 times than diatomite, and more than 10 times than terracotta as shown in FIG. 3. The terracotta has scarcely fine pores of a radius less than 0.1 μm, so that it absorbs or disorbs moisture in a very few amount as shown in FIG. 3.

In the present invention, grooves (sole) may be formed in the rear surface of the formed building material. When the formed building material with the grooves is attached to a wall, ventilating passages are securely provided between the surface of the wall and the rear surface of the formed building material, thereby improving the hazardous substance adsorbing function.

It is important in the formed building material of the present invention that the hazardous substance adsorbability of the main body is highly kept even after the front surface of the main body is glazed. Preferably, the formed building material after the glazing has hazardous substance adsorbability corresponding to 80% or more of that of the main body before the glazing.

To highly keep the hazardous substance adsorbability even after the glazing, control of the glazed area and the thickness of glaze is important. The glazing to a front surface of the main body is conducted to satisfy at least one of the following conditions (i) and (ii). To apply the graze on the front surface of the main body, any method may be employed, for example a spray glazing method, a curtain glazing method, and printing glazing method.

(i) The ratio of the area of a glass layer made of the glaze to the area of the front surface of the main body (hereinafter, referred to as “the glazed area ratio”) is 90% or less.

(ii) The maximum thickness of the glass layer made of the glaze (hereinafter, referred to only as “the maximum thickness”) is 300 μm or less.

A glazed area ratio exceeding 90% significantly decreases the hazardous substance adsorbability, so the resultant formed building material has poor hazardous substance adsorbability. On the other hand, when the glazed area ratio is less than 10%, the glazed area is too small to obtain the effect of improving its decorative property and its soil resistance. Therefore, the glazed area ratio is preferably in a range from 10% to 90%, more preferably in a range from 30% to 85%.

The glazed area ratio can be measured by ink-wiping test as will be mentioned in the following examples.

In this manner, when the glazed area ratio is set at 90% or less, the maximum thickness is not limited particularly and is preferably 500 μm or less.

When the glazed area ratio exceeds 90%, a maximum thickness exceeding 300 μm significantly loses the hazardous substance adsorbability. Therefore, the maximum thickness is preferably 300 μm or less. On the other hand, in case of too small thickness, the effect of improving its decorative property and its soil resistance by the glazing can not be obtained enough. Therefore, the maximum thickness is preferably in a range from 10 μm to 100 μm in case of the glazed area ratio from 95% to 100%, or in a range from 20 μm to 200 μm in case of the glazed area ratio from 90% to 95%.

As the glass layer is formed to have small thickness, high hazardous substance adsorbability can be obtained even when the entire front surface of the main body is glazed. This is because fine gas-permeable holes are formed in the main body by gases which are generated due to defect of the basis material or generated during the baking and the holes may be easily formed extending from the main body into the glass layer.

The aforementioned glazed area ratio and the maximum thickness are accomplished by suitably selecting the glazing method and/or suitably controlling the amount of glaze or the specific gravity of the glaze.

For example, in case of splay glazing, the glazed area ratio of 90% or less can be accomplished by splaying relatively a small amount of glaze per unit area. Also in case of the entire front surface glazed in the curtain glazing method, the maximum thickness can be set small by using a small amount of glaze per unit area.

For the glazing, a frit should be selected according to the baking. In case of rapid baking by a roller hearth kiln, a frit should have its softening point lower than the temperature for baking by 100-400 ° C. and have suitable melting viscosity. With too low viscosity, fine pores of the main body exhibiting the hazardous substance adsorption are filled by glass formed by the glazing, thus significantly losing it's the hazardous substance adsorbing function.

Accordingly, the amount of glaze and the melting viscosity of glaze (the softening point of the flits) should be suitably controlled not to lose the hazardous substance adsorbing function.

A decorative glazing method may be employed for partial glazing, not glazing the entire front surface, for instance, dots, lines, and grids. For example, by employing a printing method, the grazes applied on the main body can be spaced apart because of a mesh pattern, thereby reducing the grazed area ratio. Further, by employing a centrifuge method, the graze can be applied in a dot pattern larger than that formed by other method, thereby also reducing the grazed area ratio, thus maintaining the hazardous substance adsorbing function, and improving the decorative property by glazing patterns.

The glaze used for the glazing may be a slurry only containing a frit and water with a specific gravity from 1.01 to 1.90 and the slurry may be blended with clay and/or pigment. The blend of pigment further improves the decorative property.

The formed building material of the present invention exhibits effects removing other substances as well as formaldehyde, such as toluene, xylene, styrene, and benzene, which are known as volatile organic compounds like formaldehyde, further dioctyl phthalate, tributyl phosphate, tricresyl phosphate, chloropyrifos, and phoxim.

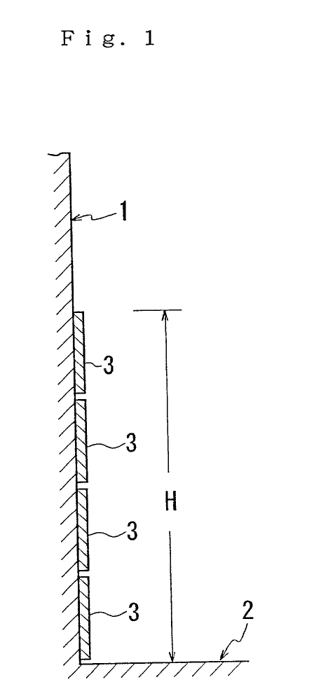

The formed building materials of the present invention are attached, for instance, to a lower portion of a wall 1 (e.g. the height H of the portion is 1.5 m or less from the floor) and a floor 2 of a room as shown in FIG. 1, thereby adsorbing and removing hazardous substances from air particularly in a lower portion of the room. It should be noted that the formed building materials 3 may be attached to an upper portion of the wall 1. Though the formed building materials 3 can be attached to a ceiling, a measure for preventing the materials from falling should be taken. For attaching the formed building materials to the room, the formed building materials are preferably attached to have an air volume ratio R, i.e. A/B (m²/m³) of 0.1 ore more, particularly 0.2 or more.

### EXAMPLES AND COMPARATIVE EXAMPLES

The present invention will be described in more detail with reference to the following examples and comparative examples.

1. Formaldehyde Removability Test: Laboratory-scale Test

### Example 1

Raw material containing the following components was milled, then pelletized with spraying, and was press molded by using a press mold to obtain a plate-like molded body.

<Components of Raw Material (Parts by Weight)>

Kanumatsuchi: 20

Clay: 60

Pottery Stone: 20

A glaze slurry was prepared by blending a frit of alkali alumino borosilicate series (the softening point: about 600° C.) and water. The glaze slurry was applied on the aforementioned molded body with 100 g per unit area (1 m²) and was baked at 850° C. by a roller hearth kiln.

The resultant baked body as a formed building material of Example 1 was measured for the grazed area ratio, the maximum thickness of grazed layer, the specific surface area of a main body, the formaldehyde removability of formed building material by the following methods. As a result, the grazed area ratio is 80%, the maximum thickness of grazed layer is 170 μm, and the specific surface area is 25 m²/g. The formaldehyde removability is shown in Table 1. A pore distribution and moisture-absorbing-and-desorbing-performance in 24 hour cycle of the product are also determined by the below-described methods, and results are shown in FIGS. 2 and 3. Data of terraccota are also shown in FIGS. 2 and 3.

<Glazed Area Ratio>

A water-color ink was applied to a front surface of the formed building material. After that, the front surface was wiped by a cloth containing water. The ratio of an area where the ink was removed was measured by microscopic observation and image processing.

<Maximum Thickness>

The maximum thickness was measured by microscopic observation of a broken surface.

<Specific Surface Area of Main Body>

Grazed portions are removed from formed building materials of examples and comparative examples to made test pieces. The specific surface area was measured according to the BET one point continuous flowing method. “MONOSORB” (manufactured by Quanta Chrome Corp.) was employed as BET specific surface area measuring apparatus.

<Formaldehyde Removability>

Test pieces were prepared by cutting formed building materials into squares of 100 mm, respectively. Each test piece was entered into a bag to seal formaldehyde (about 20 PPM, 3 L) on air base. After 10 minutes, the concentration of gas in the bag after ten minutes was measured by a gas indicator tube (manufactured by Gastech Co.). The removed ratio was obtained by the following expression.

Remove Ratio=(Initial Concentration−Concentration after 10 min)/Initial Concentration×100 (%)

[Method of Determining the “Moisture-Absorbing-and-Desorbing-Performance in 24-Hour Cycle”]

The method is conducted in a same manner as the above method of determining the “Moisture-Absorbing-and-Desorbing-Performance in 8-Hour Cycle” except that the moisture-absorbing-and-desorbing-performance is continued up to 24 hours.

[Method of Determining the Pore Distribution]

It is determined by BET method.

### Example 2

A formed building material of Example 2 was made in the same manner of Example 1 except that components of the raw material of main body were 60 parts by weight of clay, 10 parts by weight of feldspar, and 30 parts by weight of diatomaceous earth, and that a molded body was prepared by extrusion molding with adding water. The results of the measurements made in the same manner of Example 1 are shown in Table 1.

### Example 3

A formed building material of Example 3 was made in the same manner of Example 2 except that the baking temperature is 750° C. The results of the measurements made in the same manner of the preceding examples are shown in Table 1.

### Example 4

Components of the raw material of main body were 40 parts by weight of clay, 20 parts by weight of glass, and 40 parts by weight of sepiolite. The components were milled, mixed, and pelletized and was molded by press molding to obtain a molded body. A glaze slurry prepared by blending a frit of alkali alumino borosilicate series (the softening point: about 600° C.) and water was applied to the molded body with 200 g per unit area (1 m²) by the curtain glazing method and was baked at 800° C. by a roller hearth kiln. Except these, a formed building material of Example 4 was made in the same manner of Example 1. The results of the measurements made in the same manner of the preceding examples are shown in Table 1.

### Comparative Example 1

Raw material containing the same components of Example 1 was milled, mixed, and pelletized and was molded by press molding to obtain a molded body. A glaze slurry prepared by blending a frit of alkali alumino borosilicate series (the softening point: about 700° C.) and water was applied to the molded body with 100 g per unit area (1 m²) by a spray gun and was baked at 950° C. by a roller hearth kiln. Except these, a formed building material of Comparative Example 1 was made in the same manner of Example 1. The results of the measurements made in the same manner of the above examples are shown in Table 1.

### Comparative Example 2

Components of the raw material of main body were 50 parts by weight of clay, 30 parts by weight of feldspar, and 20 parts by weight of diatomaceous earth. This raw material was milled, mixed, and pelletized and was molded by press molding to obtain a molded body. A glaze slurry prepared by blending a frit of alkali alumino borosilicate series (the softening point: about 700° C.) and water was applied to the molded body with 100 g per unit area (1 m²) by a spray gun and was baked at 1000° C. by a roller hearth kiln. Except these, a formed building material of Comparative Example 2 was made in the same manner of Example 1. The results of the measurements made in the same manner of the above examples are shown in Table 1.

### Comparative Example 3

A formed building material of Comparative Example 3 was made in the same manner of Comparative Example 1 except that the glaze slurry was applied to the molded body with 300 g per unit area (1 m²). The results of the measurements made in the same manner of Example 1 are shown in Table 1.

TABLE 1

| | | Maximum | | Concentration | | |
|---|---|---|---|---|---|---|
| | Glazed | Thickness | Supecific | of Gas | | |
| | Area | of Glazed | Surface | (ppm) | | Remove |
| | Ratio | Layer | Area | | After 10 | Ratio |
| No. | (%) | (μm) | (m²/g) | Initial | min | (%) |
| Example 1 | 85 | 170 | 25 | 20 | 3.5 | 82.5 |
| Example 2 | 85 | 170 | 35 | 20 | 2 | 90 |
| Example 3 | 80 | 150 | 70 | 20 | 1 | 95 |
| Example 4 | 90 | 300 | 50 | 20 | 3 | 87.5 |
| Comparative | 85 | 200 | 7 | 20 | 15 | 25 |
| Example 1 | | | | | | |
| Comparative | 90 | 200 | 2 | 20 | 17 | 15 |
| Example 2 | | | | | | |
| Comparative | 95 | 400 | 7 | 20 | 18 | 10 |
| Example 3 | | | | | | |

As apparent from Table 1, the main body having specific surface area of 10 m^{2/}g or more can effectively remove formaldehyde.

2. Formaldehyde Removability Test: Chamber Test

<Method of Measuring Formaldehyde Removability: Chamber Test>

Aquarius solution of formalin 0.2 g (containing 37% of formaldehyde) was poured in a test chamber of 10 m³. After 24 hours, air in the chamber was aspirated and scavenged for 30 minutes and formaldehyde was measured by DNPH-HPLC analysis. The removed ratio was obtained by the following expression.

Remove Ratio=(Initial Concentration−Concentration after 24 hours)/Initial Concentration×100

### Example 5

The formed building materials of Example 3 were disposed for an area of 2 m² in the aforementioned test chamber (air volume ratio 0.2). The removability was assessed. The result is shown in Table 2.

### Example 6

The formed building materials of Example 3 were disposed for an area of 5 m² in the aforementioned test chamber (air volume ratio 0.5). The removability was assessed. The result is shown in Table 2.

### Example 7

The formed building materials of Example 1, having function of removing formaldehyde and the like and improving the quality of indoor air, were disposed for an area of 2 m² on a floor of the aforementioned test chamber. The removability was assessed. The result is shown in Table 2.

### Example 8

The formed building materials of Example 1, having function of removing formaldehyde and the like and improving the quality of indoor air, were disposed for an area of 2 m² on a lower portion of the aforementioned test chamber. The removability was assessed. The result is shown in Table 2.

### Comparative Example 4

The formed building material of Example 3 were disposed for an area of 0.5 m² in the aforementioned test chamber (air volume ratio 0.05). The removability was assessed. The result is shown in Table 2.

### Comparative Example 5

The formed building materials of Example 1, having function of removing formaldehyde and the like and improving the quality of indoor air, were disposed for an area of 2 m² on a ceiling of the aforementioned test chamber. The removability was assessed. The result is shown in Table 2.

### Comparative Example 6

The formed building materials of Example 1, having function of removing formaldehyde and the like and improving the quality of indoor air, were disposed for an area of 2 m² on an upper portion of the wall of the aforementioned test chamber. The removability was assessed. The result is shown in Table 2.

TABLE 2

| | Initial Concentra- | Concentration | |
|---|---|---|---|
| | tion of | of Gas | |
| No. | Gas (ppm) | After 24 hr (ppm) | Remove Ratio (%) |
| Example 5 | 0.80 | 0.04 | 95 |
| Example 6 | 0.80 | 0.02 | 97.5 |
| Example 7 | 0.80 | 0.14 | 82.5 |
| Example 8 | 0.80 | 0.20 | 75 |
| Comparative | 0.80 | 0.4 | 50 |
| Example 4 | | | |
| Comparative | 0.80 | 0.50 | 37.5 |
| Example 5 | | | |
| Comparative | 0.80 | 0.36 | 55 |
| Example 6 | | | |

As described above, the present invention can provide a formed building material having hazardous substance adsorbing function and of which front surface is allowed to be glazed, thereby improving its decorative property, improving its soil resistance, and thus proving high commercial value. In addition, the present invention can provide a room having excellent hazardous gas removing function.

What is claimed is:

1. A formed building material produced by baking wherein a glaze is applied to a front surface of a main body of the formed building material,
wherein the specific surface area of the main body is 10 m²/g or more, and wherein said main body has porosity of 20-50%, and more than 40% of pores of the main body have a radius of less than 0.1 μm.

2. A formed building material as claimed in claim 1, wherein the glaze forms a glass layer on 90% or less of the entire front surface area of the main body.

3. A formed building material as claimed in claim 1, wherein the maximum thickness of the glass layer formed by the glaze is 300 μm or less.

4. A room wherein the formed building material as claimed in claim 1 is attached to a lower portion of a wall or a floor of the room.

5. A room as claimed in claim 4, wherein the glaze forms a glass layer on 90% or less of the entire front surface area of the main body.

6. A room as claimed in claim 4, wherein the maximum thickness of the glass layer formed by the glaze is 300 μm or less.

7. A room as claimed in claim 4, wherein the formed building material is attached such that the air volume ratio is 0.1 (m²/m³) or more.

8. A room wherein a formed building material having hazardous substance adsorbing function is attached to a lower portion of a wall or a floor of the room, and wherein the formed building material has porosity of 20-50%, and more than 40% of pores of the material have a radius of less than 0.1 μm.

9. A room as claimed in claim 8, wherein the formed building material is attached such that the air volume ratio is 0.1 (m²/m³) or more.
